(19) United States
(12) Patent Application Publication
(10) Pub. No.: US 2005/0026636 A1
(43) Pub. Date: Feb. 3, 2005

(54) Method for connecting to wireless internet site by using phone number

(76) Inventor: Hyo-Sung Yoon, Jeollabuk-do (KR)

Correspondence Address: JONES DAY, 222 EAST 41ST ST, NEW YORK, NY, 10017, US

(21) Appl. No.: 10/498,627

(22) PCT Filed: Dec. 6, 2002
(86) PCT No.: PCT/KR02/02367

(30) Foreign Application Priority Data
Dec. 15, 2001 (KR) 1020010079759

(51) Int. Cl. H04Q 7/20

(52) U.S. Cl. 455/466

(57) ABSTRACT

Disclosed is a method for connection to a wireless Internet site by using a mobile terminal such as a cellular phone or PDA, which enables to easily connect to a specific wireless Internet site through the processes of obtaining a phone number of a caller mobile terminal through a voice communication link and then sending a message containing a connection URL to the mobile terminal. Thus, this method may facilitate easy access to a wireless Internet site, so enlarging utilization of a wireless Internet and contriving expansion of data communications through mobile terminals. In addition, this method enables to access a wireless WEB site without inputting complex URLs separately, so helping to overcome limitation, existing in data communications of mobile terminals such as a cellular phone.

### TECHNICAL FIELD

The present invention relates to a method for connecting to a wireless Internet by using a mobile terminal such as a cellular phone or a PDA, and more particularly to a method for easily connecting to a specific wireless Internet site by obtaining a phone number of a mobile terminal of a caller trough a voice communication link and then sending a message having a URL to the mobile terminal.

### BACKGROUND ART

As the data communication network for connecting plural computers is developed together with the advent of World Wide Web, the computer system also acts an important role as an information communication terminal for giving free access to information existing all over the world.

A client who requests information may search desired information using a Web browser such as Internet Explorer or Navigator and easily get various information from a server computer containing the corresponding information.

On the other hand, the mobile equipments such as a cellular phone or a PDA are also changed to use a data-based technique from the conventional voice-based technique. In other words, the cellular phone is changed from a telephone machine for voice communication to an information communication terminal enabling the data communication.

There are conventionally used two ways for connecting to a wire Internet site using a mobile communication terminal such as a cellular phone, in brief.

First, a use connects to a wireless portal site through a gateway of a mobile communication service provider, and then searches subordinated sites registered in the portal site in order for selection.

Second, a use directly inputs a URL to access a wireless site designated by the corresponding URL.

The first way allows the user to visit formal sites registered in the wireless portal site, thereby restricting free selection of the Internet users. In addition, the second way is inconvenient since the user would not easily input the URL due to a physical structure of the mobile communication terminal.

Thus, there have been various technical attempts for overcoming the limit of the wireless communication.

Korean Laid-open Patent Publication No. 2000-54046 discloses a method for connecting a mobile communication terminal to a desired site when a user just inputs an ID in the mobile communication terminal, by constructing a database in which the ID is matched with a URL of a specific wireless site in advance.

However, in order to use this method, the user of the mobile communication terminal should remember Ids of various sites in full and the matching database should be prepared in advance.

Korean Laid-open Patent Publication Nos. 2001-83834 and 2001-7743 disclose a method for connecting to a wireless Internet, which constructs a database in which a phone (or, a guide code) is matched with a URL. In the method, if a specific phone number (or, a guide code) is input from a mobile communication terminal to a wireless data communication network, a URL matched with the phone number (or, the guide code) is searched and then the mobile communication terminal is guided to a homepage designated by the URL.

However, the method also essentially requires constructing database and server for matching a specific phone number (or, a specific guide code) to a specific URL and then, when a phone number (or, a guide code) is input, extracting a URL corresponding to the phone number (or, the guide code) and then guiding the mobile communication terminal to a homepage designated by the URL.

Thus, there is still needed a method for conveniently accessing a desired wireless homepage by using a mobile terminal without constructing a separate database or a server.

### DISCLOSURE OF INVENTION

The present invention is designed to solve the technical needs, therefore an object of the invention is to provide a method for guiding a user to conveniently access a desired wireless homepage by use of a mobile terminal such as a cellular phone.

In addition, another object of the invention is to provide a method for guiding a user to a desired wireless homepage just by inputting a phone number for voice communication without constructing a separate database.

In order to accomplish the above object, as a first preferred mode of the present invention, there is provided a method for connecting to a wireless Internet, particularly a server computer which operates a specific wireless Internet site, by using a mobile terminal which is capable of voice communication and data communication, which method includes the steps of: (1) requesting a voice call to the server computer by using the mobile terminal; (2) assuring a voice communication line between the mobile terminal and the server computer and obtaining a phone number of the mobile terminal; (3) generating a wireless message containing a URL designating a wireless Internet site; (4) transmitting the wireless message to the mobile terminal on the basis of the obtained phone number; and (5) requesting a page designated by the URL written in the wireless message and then outputting the page through the mobile terminal.

The method for connecting to a wireless Internet as the first mode may further include the step of, at the called part, forcibly disconnecting the voice communication link established between the mobile terminal and the server computer.

As a second mode of the present invention, there is also provided a method for connecting to a wireless Internet, particularly a server computer which operates a specific wireless Internet site, by using a mobile terminal which is capable of voice communication and data communication, which method includes the steps of: (1) requesting a voice call to the server computer by using the mobile terminal; (2) assuring a voice communication line between the mobile terminal and the server computer and obtaining a phone number of the mobile terminal; (3) generating a wireless message containing a URL designating a wireless Internet site; (4) transmitting the wireless message to the mobile terminal on the basis of the obtained phone number; (5) at the calling part, forcibly disconnecting the voice communication link established between the mobile terminal and the server computer; and (6) requesting a page designated by the URL written in the wireless message and then outputting the page through the mobile terminal.

The method for connecting to a wireless Internet according to the first and second modes may further include the step of determining whether the wireless message is a message for the corresponding mobile terminal and then receiving the wireless message.

At this time, the wireless message may further contain a Teleservice ID (TI) for identifying a service character.

Thus, the method for connecting to a wireless Internet according to the first and second modes may further include the step of determining whether the TI written in the wireless message is coincident with a TI of the mobile terminal.

In addition, the phone number of the mobile terminal may be input into the server computer by the caller himself/herself.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows a network system in which the present invention is realized;

FIG. 2 is a block diagram showing one preferable example of a mobile terminal of a caller for realizing the method of the present invention;

FIG. 3 is a block diagram showing one preferable example of a server computer of the called for realizing the method of the present invention;

FIG. 4 is a flow chart for illustrating the method for connecting to a wireless Internet according to an embodiment of the present invention; and

FIG. 5 is a flow chart for illustrating the method for connecting to a wireless Internet according to another embodiment of the present invention.

### BEST MODES FOR CARRYING OUT THE INVENTION

Hereinafter, preferred embodiments of the present invention will be described in detail with reference to the accompanying drawings.

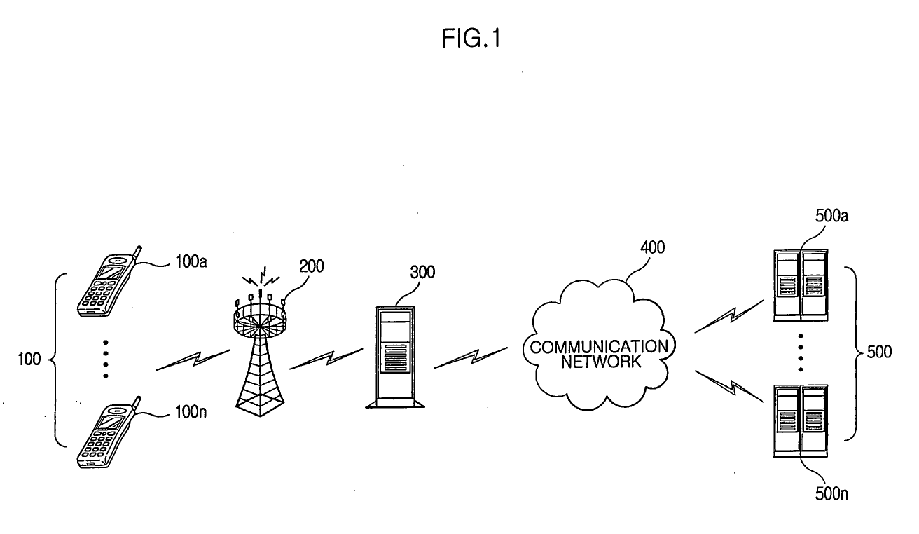

FIG. 1 shows a system for realizing a method for connecting to a wireless Internet according to the present invention.

As shown in FIG. 1, the system includes a mobile terminal 100 acting for requesting information, a server computer 500 acting for providing information, and a communication network system 200, 300 and 400 for wire/wireless interfacing between the mobile terminal 100 and the server computer 500.

The mobile terminal 100 is an information communication equipment enabling voice communication and data communication during movement. Particularly, a cellular phone or a PDA (Personal Digital Assistant) is preferably used.

The server computer 500 acts as a voice communication system for performing voice communication with the mobile terminal 100. The server computer 500 also acts as a computer system for providing a wireless web page, made in a language such as WML, XML, XHTML and HDML, to the mobile terminal.

This server computer 500 is a mass storage computer system including a central processing unit, RAM, ROM, a network interface, a data memory device and so on. A workstation or a traditional personal computer having a significant amount of memory and processing capacity may be used.

The server computer 500 may process a large amount of works by enormous mathematical calculation in information processing or database searching. A Pentium microprocessor manufactured by Intel can be mainly used as the central processing unit.

The communication network system is composed of a wire network and a wireless network 400, in which the wireless communication network is also composed of a base station 200 and a mobile communication system 300.

The wire communication network 400 includes an Internet, a local network, a wire area network, an Intranet, an Extranet and so on, which are based on Public Switched Telephone Network (PSTN). In addition, the mobile communication system is, for example, a system of the mobile communication service provider including a WAP gateway and acts for interfacing the wireless network and the wire network.

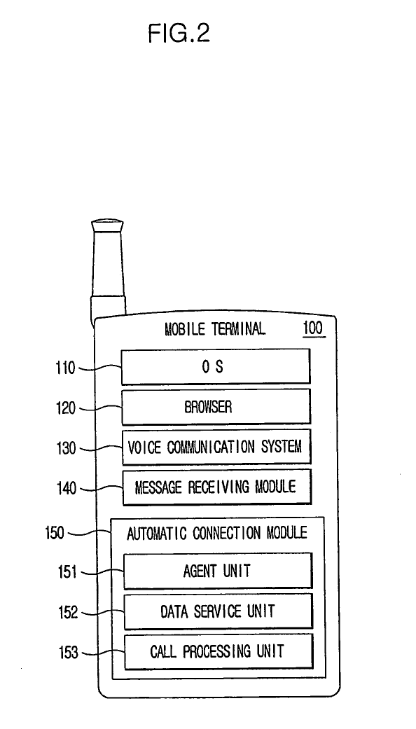

Hereinafter, specific functional configurations of the mobile terminal 100 are described in detail with reference to FIG. 2.

The mobile terminal 100 includes an Operating System (OS) 110, a browser 120, a voice communication system 130, a message receiving module 140 and an automatic connection module 150.

The OS 110 is system software providing a platform for efficient use and management of application programs for the browser, the message receiving module and the automatic connection module.

The browser 120 is a mobile browser for downloading a wireless web page designated by a selected URL and then displaying the web page on a screen so that a user of the mobile terminal may look it. Typically, a Mobile Explorer (ME) of Microsoft Co. can be used.

The voice communication system 130 is composed of a transmitting/receiving unit, a digital modulating/demodulating unit, a signal-processing unit, a voice coding/decoding unit (or, CODEC), and so on. The voice communication system 130 processes a transmitting signal or a received signal for enabling voice communication. The voice communication system 300 is defined to have a configuration of a telephone terminal based on, for example, CDMA or GSM.

The message receiving module 140 plays a role of receiving a wireless message such as SMS (Short Message Service) or MMS (Multimedia Message Service) from the server computer 500 and then transmitting the wireless message to an agent unit 151 of the automatic connection module 150.

The automatic connection module 150 is an application program for substantially acting a wireless Internet connection function according to the present invention. The automatic connection module 150 includes an agent unit 151, a data service unit 152 and a call processing unit 153.

The agent unit 151 determines whether a Teleservice ID (TI) of the received wireless message is coincident with a previously-set service type. When coincident with the service type, the agent unit 151 receives the wireless message and analyzes its priority.

The call processing unit 153 disconnects a voice communication line currently established between the mobile terminal of a caller and the server computer of the called when receiving a voice call disconnection request from the agent 151.

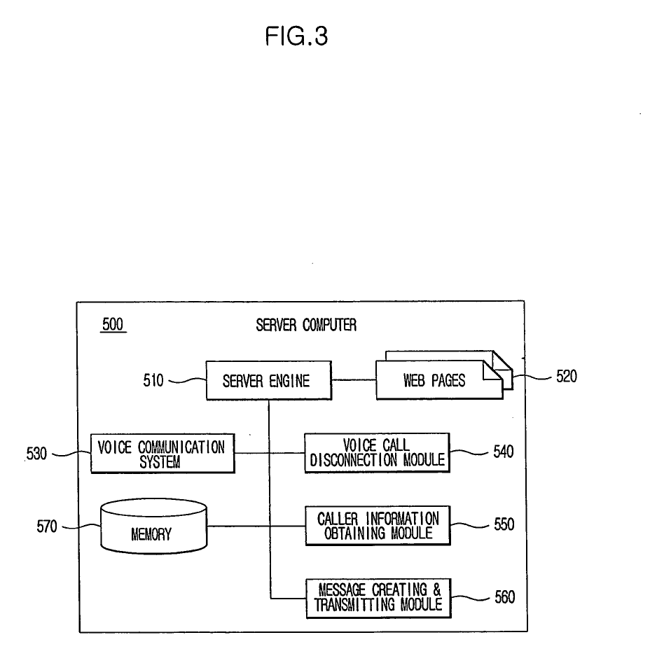

The data service unit 152 connects the mobile terminal 100 to a URL address written in the wireless message transmitted from the agent unit 151, for data communication. In other words, the data service unit 152 automatically executes the mobile browser 120 so that the browser requests a server engine 510 (see FIG. 3) of the server computer to download a wireless web page designated by the URL address.

Now, functional configurations of the above-mentioned server computer are described in detail with reference to FIG. 3.

As shown in FIG. 3, the server computer 500 includes a server engine 510, wireless web pages 520, a voice communication system 530, a voice call disconnection module 540, a caller information obtaining module 550, a message creating/transmitting module 560 and a memory 570.

Here, the server engine 510 acts a role of operating the system. Particularly, the server engine 510 receives a request for accessing a wireless web page 520 identified by URL (Uniform Resource Locator) and then provides the wireless web page 520 to a client system, or the mobile terminal 100.

The voice communication system 530 acts for processing a voice call requested by the mobile terminal 100. Particularly, in case it is impossible to obtain a caller phone number from the mobile communication system 300, the voice communication system 530 also acts a role of an automatic voice guidance system (e.g., Automatic Response System (ARS)) for guiding the caller to directly input a phone number.

The voice call disconnection module 540 is a program module for forcibly disconnecting a voice communication link established between the mobile terminal 100 and the voice communication system 530 by the request of the caller. At this time, the disconnection of the voice call is preferably performed after obtaining the caller phone number.

In addition, the caller information obtaining module 550 is a program module for temporarily storing the caller phone number obtained from the mobile communication system 300 or input by the caller in the state that a voice communication link is established between the mobile terminal 100 and the voice communication state 530. The caller information obtaining module 550 stores the phone number into the memory 570.

The message creating/transmitting module 550 is a program module for creating a wireless message in which a Teleservice ID (TI) for classifying a service character and a URL corresponding to a main page of a wireless web site are written, and then transmitting the wireless message to the caller phone number stored in the memory 570.

Here, the Teleservice ID (TI) is an inherent code for defining the wireless Internet automatic connection service according to the present invention. The TI is set on the agreement with the mobile terminal.

In other words, the agent unit 151 of the mobile terminal recognizes that the wireless message transmitted from the server computer is information having the best priority. Thus, the agent unit 151 stops all service currently executed in the mobile terminal and then automatically connects the mobile terminal to the URL written in the wireless message.

In addition, the wireless message contains all message information which is capable of being transmitted to the mobile terminal through the wireless data communication network. Particularly, the wireless message is preferably an SMS (Short Message Service) or an MMS (Multimedia Message Service).

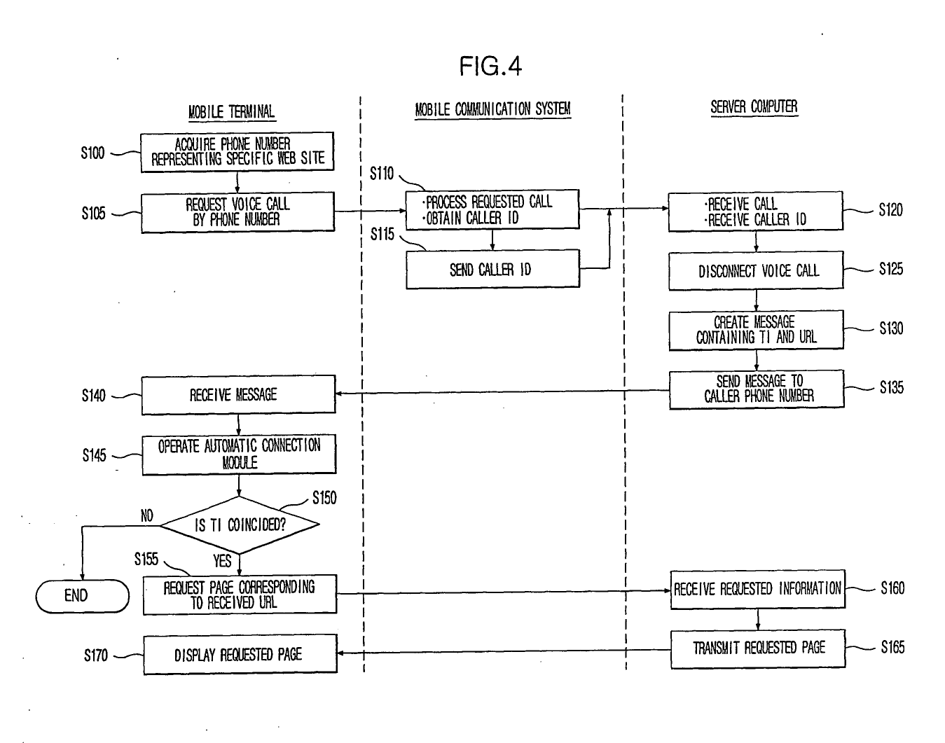

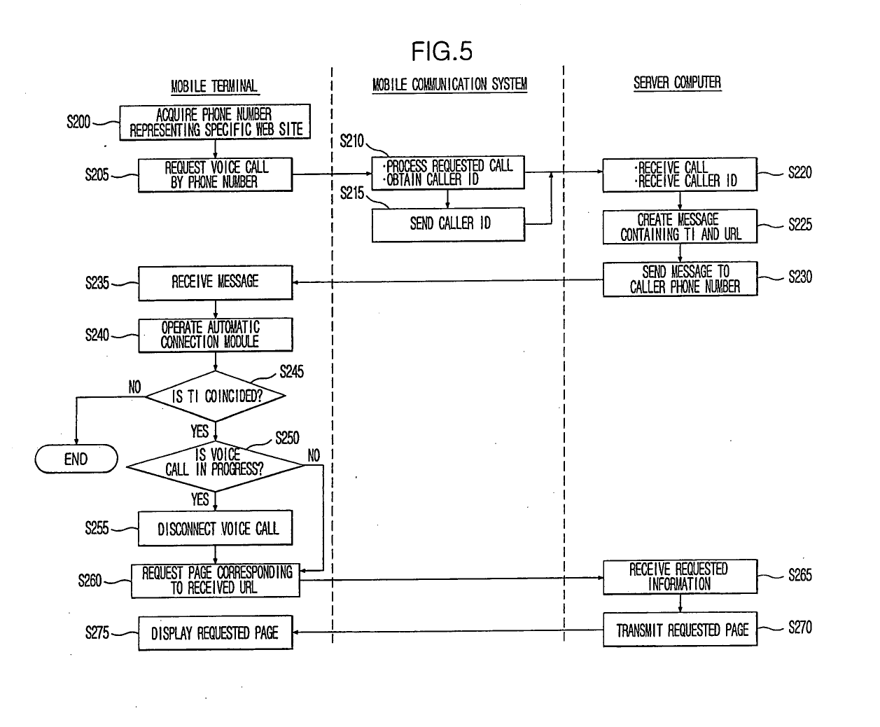

Now, the method for connecting to a wireless Internet according to a preferred embodiment of the present invention is described in detail with reference to FIGS. 4 and 5.

The wireless Internet connection method of the present invention is classified into two embodiments as follows depending on a side which disconnects the voice call.

First Embodiment

In the present embodiment, the voice communication link established between the caller mobile terminal and the called voice communication system is forcibly disconnected by the called, as seen in the flow chart shown in FIG. 4.

Now, the wireless Internet connection method according to the present embodiment is described in detail with reference to FIG. 4.

At first, a caller acquires a phone number which represents a wireless web site the caller desires to visit (S100). Then, the caller requests a voice call to the phone number by use of the caller mobile terminal 100 (S105).

The mobile communication system 300 receives the voice call request from the mobile terminal 100 of the caller. The mobile communication system 300 transmits this call to a called phone (i.e., the voice communication system) and then obtains a phone number of the caller (i.e., Caller ID) (S110).

The caller phone number (Caller ID) obtained as above is transmitted to the called phone (i.e., the voice communication system) by the mobile communication system 300 (S115).

On the other hand, the voice communication system 530 of the server computer receives the call requested by the caller. The voice communication system 530 also receives the caller phone number transmitted from the mobile communication system 300 and then temporarily stores the caller phone number in the memory 570 (S120).

If the called voice communication system answers to the request of the caller terminal, a voice communication link enabling transmission/receiving of voice information is established between the mobile terminal 100 and the server computer 500.

On the other hand, the voice call disconnection module 540 of the server computer forcibly disconnects the voice communication link formed between the mobile terminal 100 of the caller and the voice communication system 530 of the called (S125).

In addition, the message creating/transmitting module 560 creates a wireless message in which a Teleservice ID (TI) for distinguishing a service of the present embodiment from other service and a URL address used for accessing a main page of a wireless web site are written (S130).

The message creating/transmitting module 560 reads the caller phone number from the memory 570, and then transmits the wireless message to the phone number (S135).

The message receiving module 140 of the mobile terminal receives the wireless message from the server computer (S140), and then executes the automatic connection module 150 which is already installed in the mobile terminal (S145).

The agent unit 151 of the automatic connection module analyzes the TI (Teleservice ID) written in the wireless message in order to determine whether it is corresponding to its own service. In other words, the agent unit 151 compares the received TI (Teleservice ID) with a stored TI (Teleservice ID) in order to determine whether they are coincident (S150).

At this time, in case the service distinguished by the TI is corresponding to the agent, the agent unit 151 transmits the wireless message to the data service unit 152. The data service unit 152 then requests the server computer 500 to download a wireless web page designated by the URL written in the wireless message (S155).

The server engine 510 of the server computer receiving the request information extracts the wireless web page corresponding to the URL and then transmits it to the browser 120 of the mobile terminal (S160) (S165).

The browser 120 downloading the web page made in a wireless mark-up language such as WML and HDML decodes the web page and then display it on the screen of the mobile terminal 100 (S170).

Though it is described in the present embodiment that the voice call is disconnected in the step S125 just after the caller phone number is obtained, the present invention is not limited to that case. In other words, the disconnection of the voice call can be performed after creation of the wireless message, or even after the transmission of the wireless message.

In addition, though it is described in the steps S110˜S120 of the present embodiment that the caller phone number is automatically transmitted from the mobile communication system to the server computer, the present invention is not limited to that case.

In other words, the present embodiment may be modified so that the caller directly input the phone number by himself/herself according to the guidance of the voice call system (e.g., ARS) after the voice communication link is established between the server computer 500 and the mobile terminal 100.

Second Embodiment

The present embodiment is different from the first embodiment in the point that the caller performs the disconnection of the voice call. In other words, as seen in the flow chart shown in FIG. 5, the voice communication link established between the caller mobile terminal and the called voice communication system is forcibly disconnected by the caller.

Now, the wireless Internet connection method according to the present embodiment is described in detail with reference to FIG. 5.

At first, a caller acquires a phone number which represents a wireless web site the caller desires to visit (S200). Then, the caller requests a voice call to the phone number by use of the caller mobile terminal 100 (S205).

The mobile communication system 300 receives the voice call request from the mobile terminal 100 of the caller. The mobile communication system 300 transmits this call to a called phone (i.e., the voice communication system) and then obtains a phone number of the caller (i.e., Caller ID) (S210).

The caller phone number (Caller ID) obtained as above is transmitted to the called phone (i.e., the voice communication system) by the mobile communication system 300 (S215).

On the other hand, the voice communication system 530 of the server computer receives the call requested by the caller. The voice communication system 530 also receives the caller phone number transmitted from the mobile communication system 300 and then temporarily stores the caller phone number in the memory 570 (S220).

If the called voice communication system answers to the request of the caller terminal, a voice communication link enabling transmission/receiving of voice information is established between the mobile terminal 100 and the server computer 500.

In the state that the voice communication link is established as above, the message creating/transmitting module 560 creates a wireless message in which a Teleservice ID (TI) for distinguishing a service of the present embodiment from other service and a URL address used for accessing a main page of a wireless web site are written (S225).

The message creating/transmitting module 560 reads the caller phone number from the memory 570, and then transmits the wireless message to the phone number (S230).

The message receiving module 140 of the mobile terminal receives the wireless message from the server computer (S235), and then executes the automatic connection module 150 which is already installed in the mobile terminal (S240).

The agent unit 151 of the automatic connection module analyzes the TI (Teleservice ID) written in the wireless message in order to determine whether it is corresponding to its own service. In other words, the agent unit 151 compares the received TI (Teleservice ID) with a stored TI (Teleservice ID) in order to determine whether they are coincident (S245).

At this time, in case the service distinguished by the TI is corresponding to the agent, the agent unit 151 determines whether the voice call is progressed in the mobile terminal (S250).

If the voice call of the mobile terminal is in progress, it is requested for the call processing unit 153 to disconnect the voice call of the mobile terminal (S255).

In the state that the progressed voice call is disconnected as described above, the agent unit 151 calls the data service unit 152 so that the mobile terminal may achieve the data communication with the server computer on the basis of the URL written in the wireless message.

The data service unit 152 called as above then requests download of a wireless web page, designated by the URL written in the wireless message, to the server computer 500 (S260).

On the other hand, if the voice call is not progressed in the mobile terminal in the step S250, the agent unit 151 directly calls the data service unit 152 in order to execute the step S260.

The server engine 510 of the server computer receiving the request information from the data service unit of the mobile terminal then extracts the wireless web page corresponding to the URL and transmits it to the browser 120 of the mobile terminal (S265) (S270).

The browser 120 downloading the web page made in a wireless mark-up language such as WML and HDML decodes the web page and then display it on the screen of the mobile terminal 100 (S275).

Though it is described in the steps S210˜S220 of the present embodiment that the caller phone number is automatically transmitted from the mobile communication system to the server computer, the present invention is not limited to that case.

In other words, the present embodiment may be modified so that the caller directly input the phone number by himself/herself according to the guidance of the voice call system (e.g., ARS) after the voice communication link is established between the server computer 500 and the mobile terminal 100.

### INDUSTRIAL APPLICABILITY

Thus, the wireless Internet connection method of the present invention may facilitate easy access to a wireless Internet site, thereby enlarging utilization of a wireless Internet and contriving expansion of data communications through mobile terminals.

In addition, this method enables a user to access a wireless WEB site without inputting complex URLs separately, thereby helpful to overcome limitation existing in data communications of mobile equipments, particularly mobile terminals such as a cellular phone.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A method for connecting to a wireless Internet, particularly a server computer which operates a specific wireless Internet site, by using a mobile terminal which is capable of voice communication and data communication, the method comprising the steps of:
requesting a voice call to the server computer by using the mobile terminal;
assuring a voice communication line between the mobile terminal and the server computer and obtaining a phone number of the mobile terminal;
generating a wireless message containing a URL designating a wireless Internet site;
transmitting the wireless message to the mobile terminal on the basis of the obtained phone number; and
requesting a page designated by the URL written in the wireless message and then outputting the page through the mobile terminal.

2. A method for connecting to a wireless Internet according to claim 1, further comprising the step of, at the called part, forcibly disconnecting the voice communication link established between the mobile terminal and the server computer.

3. A method for connecting to a wireless Internet, particularly a server computer which operates a specific wireless Internet site, by using a mobile terminal which is capable of voice communication and data communication, the method comprising the steps of:
requesting a voice call to the server computer by using the mobile terminal;
assuring a voice communication line between the mobile terminal and the server computer and obtaining a phone number of the mobile terminal;
generating a wireless message containing a URL designating a wireless Internet site;
transmitting the wireless message to the mobile terminal on the basis of the obtained phone number;
at the calling part, forcibly disconnecting the voice communication link established between the mobile terminal and the server computer; and
requesting a page designated by the URL written in the wireless message and then outputting the page through the mobile terminal.

4. A method for connecting to a wireless Internet according to claim 2 or 3, further comprising the step of determining whether the wireless message is a message for the corresponding mobile terminal and then receiving the wireless message.

5. A method for connecting to a wireless Internet according to claim 4,
wherein the wireless message further contains a Teleservice ID (TI) for identifying a service character.

6. A method for connecting to a wireless Internet according to claim 5, further comprising the step of determining whether a TI written in the wireless message is coincident with a TI of the mobile terminal,
whereby the mobile terminal receives only the wireless message having the coincided TI.

7. A method for connecting to a wireless Internet according to claim 6,
wherein the wireless message is a SMS (Short Message Service) in which a callback URL is written.

8. A method for connecting to a wireless Internet according to claim 2 or 3,
wherein the phone number of the mobile terminal is input into the server computer by the caller.
